(19) United States
(12) Patent Application Publication
(10) Pub. No.: US 2019/0108563 A1
(43) Pub. Date: Apr. 11, 2019

(54) METHODS, SYSTEMS, NETWORKS, AND MEDIA FOR DETERMINING LOCAL RETAIL AVAILABILITY

(71) Applicant: MasterCard International Incorporated, Purchase, NY (US)

(72) Inventors: Po Hu, Norwalk, CT (US); Shen Xi Meng, Millwood, NY (US); Fuyuan Xiao, White Plains, NY (US)

(73) Assignee: MasterCard International Incorporated, Purchase, NY (US)

(21) Appl. No.: 15/726,061

(22) Filed: Oct. 5, 2017

(51) Int. Cl. G06Q 30/06; G06Q 30/02; G06Q 10/04; G06F 17/10; G06F 17/30; G06N 99/00

(52) U.S. Cl. CPC G06Q 30/0601; G06Q 30/0255; G06Q 30/0261; G06N 99/005; G06F 17/10; G06F 17/3087; G06Q 10/04

(57) ABSTRACT

An apparatus for determining local availability of a merchant can include a processor configured to communicate with a consumer transaction database. The processor can be configured to identify an estimated location of a potential consumer based at least in part on transaction activity of the potential consumer obtained from the consumer transaction database. The processor can also be configured to identify, for each merchant category, a location of a merchant located closest to the estimated location of the potential consumer from a plurality of merchants in the merchant category. The processor can also be configured to determine, for each merchant category, whether the potential consumer has local availability of a merchant based on the identified location of the merchant located closest to the estimated location of potential consumer for the corresponding merchant category.

### BACKGROUND

The disclosed subject matter relates to methods, systems, networks, and media for determining local retail availability.

With the availability of different forms of consumers' purchasing behavior, merchants, financial institutions, and advertisers are developing models to better target potential consumers. However, information on local availability for a particular type of store with respect to each available consumer has been missing from such models, due to the lack of availability of such forms of user data. Such information on local retail availability is often critical in determining user shopping behavior. For example, if a particular consumer has to drive over 100 miles to reach the nearest camping and outdoor sports store, that consumer will likely not be incentivized upon receipt of a promotion for such a store to drive such a long distance. Instead, the particular consumer will likely buy camping and outdoor sports equipment from an online merchant. Currently, there is no such information that identifies the local availability of retail stores mapped to each consumer. Accordingly, shopping predictions made by merchants, advertisers, and other third parties about their potential consumers is missing a key parameter used to form consumers' shopping patterns—local retail availability.

Accordingly, there exists a need to determine local retail availability of different categories of merchants on a per consumer basis to better understand and influence consumers' shopping behavior.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a computer-implemented method for determining local retail availability is disclosed. The computer-implemented method can include identifying, by a processing circuitry, an estimated location of a potential consumer based at least in part on transaction activity of the potential consumer. The method can include identifying, by the processing circuitry and for each merchant category, a location of a merchant located closest to the estimated location of the potential consumer from a plurality of merchants in the merchant category. The method can further include determining, by the processing circuitry and for each merchant category, whether the potential consumer has local availability of a merchant based on the identified location of the merchant located closest to the estimated location of potential consumer for the corresponding merchant category. The method can further include providing, by the processing circuitry, the potential consumer with a promotion to an electronic commerce merchant in a merchant category to which the potential consumer does not have local availability.

For purpose of illustration and not limitation, identifying the estimated location of the potential consumer can further include identifying a location associated with each transaction conducted by the potential consumer within a predetermined period of time based on the transaction activity of the potential consumer. The method can further include performing a weighted average of the locations of one or more transactions from the transaction activity of the potential consumer. In some embodiments, the method can further include removing, from the weighted average, locations of transactions that are conducted when the potential consumer is temporarily conducting transactions at a location that is not in his typical location. In some embodiments, performing the weighted average can include calculating an optimized parameter at a consumer level. The optimization parameter can be updated at a per transaction level based on each transaction activity of the potential consumer. In some embodiments, the optimized parameter can be determined by iterating through different parameter values until a parameter value is found that minimizes deviations between empirical values of measured locations from each transaction activity and the estimated location.

For purpose of illustration and not limitation, the deviations can be calculated using a machine learning algorithm that performs a minimum of least squares between measured locations from each transaction activity and the estimated location. In some embodiments, calculating the optimized parameter can include calculating an initial parameter for each transaction based on the square average error measured between the location of each transaction activity and the estimated location and the frequency of a parameter level corresponding to the transaction activity. In some embodiments, calculating the optimized parameter can include calculating a sum of square average error using a two-dimensional distance value, wherein the two-dimensional distance value is generated based on an orthodromic distance formula used to calculate the shortest distance between two points on the surface of sphere.

For purpose of illustration and not limitation, the method can include generating targeted promotions to the potential consumer based on the determination of local availability of a merchant in each merchant category.

For purpose of illustration and not limitation, the method can include updating a model of consumer shopping behavior based on the determination of local availability of a merchant for each merchant category. The model can include information on spending patterns indicating needs of the potential consumer and price range of purchases made by the potential consumer.

In accordance with another aspect of the disclosed subject matter, an apparatus for determining local availability of a merchant is disclosed. The apparatus can include a processor configured to communicate with a consumer transaction database. The processor can be configured to identify an estimated location of a potential consumer based at least in part on transaction activity of the potential consumer obtained from the consumer transaction database. The processor can be configured to identify, for each merchant category, a location of a merchant located closest to the estimated location of the potential consumer from a plurality of merchants in the merchant category. The processor can be further configured to determine, for each merchant category, whether the potential consumer has local availability of a merchant based on the identified location of the merchant located closest to the estimated location of potential consumer for the corresponding merchant category. The processor can be further configured to provide the potential consumer with a promotion to an electronic commerce merchant in a merchant category to which the potential consumer does not have local availability.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for calculating local retail availability according to an illustrative embodiment of the disclosed subject matter.

FIG. 3 is a diagram illustrating the calculation of the shortest distance between two points on a surface of a sphere according to an illustrative embodiment of the disclosed subject matter.

FIG. 4 is a table illustrating the distance from various merchants to different zip codes according to an illustrative embodiment of the disclosed subject matter.

FIG. 5 is a table illustrating the estimated consumer locations for various consumer locations according to an illustrative embodiment of the disclosed subject matter.

FIG. 6 is a table illustrating an example of different transaction information of a particular consumer and location information associated with each transaction according to an illustrative embodiment of the disclosed subject matter.

FIG. 7 is a table illustrating calculation of initial optimization parameters using square average error in latitude information according to an illustrative embodiment of the disclosed subject matter.

FIG. 8 is a table illustrating calculation of weighting coefficients using the sum of square of error in latitude information according to an illustrative embodiment of the disclosed subject matter.

FIG. 9 is a flow chart illustrating a representative method for calculating local retail availability, implemented according to an illustrative embodiment of the disclosed subject matter.

FIG. 10 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for determining local retail availability.

The accompanying figures, where like reference numerals refer to identical or functionally similar elements throughout the separate views, further illustrate various embodiments and explain various principles and advantages all in accordance with the disclosed subject matter. While the present disclosed subject matter is described with respect to using methods, systems, networks, and media for determining local retail availability, one skilled in the art will recognize that the disclosed subject matter is not limited to the illustrative embodiments. For example, the methods, systems, networks, and media for calculating local retain availability can be used with a wide variety of retail applications, such as determining the local availability of restaurants, bars, movie theaters, recreation parks, and a variety of other vendors where consumers spend money.

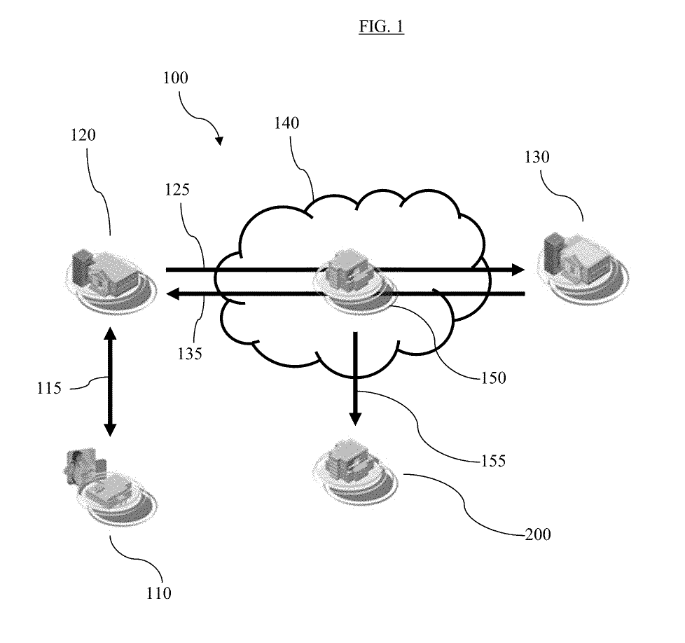

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. MasterCard® payment card system interchange network is a proprietary communications standard promulgated by MasterCard International Incorporated® based on the ISO 8583 message format for the exchange of financial transaction data between financial institutions that are consumers of MasterCard International Incorporated. (MasterCard is a registered trademark of MasterCard International Incorporated located in Purchase, N.Y.)

As embodied herein, the payment network 100 for collecting funds can include at least one merchant 110 connected to at least one electronic payment network 140, either directly or through an acquirer 120 via connection 115. At least one acquirer 140 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial consumer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or web site 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, or contactlessly from a near-field communication (NFC) device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one payment network server 150 can be connected to the electronic payment network 140 and configured to automatically capture the data representing a plurality of variables related to payment card transactions from the electronic payment network 140. Additionally, the payment network server can be connected to a system 200 for predicting acceptance of a commercial card product either by the electronic payment network 140 or a separate connection 155. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

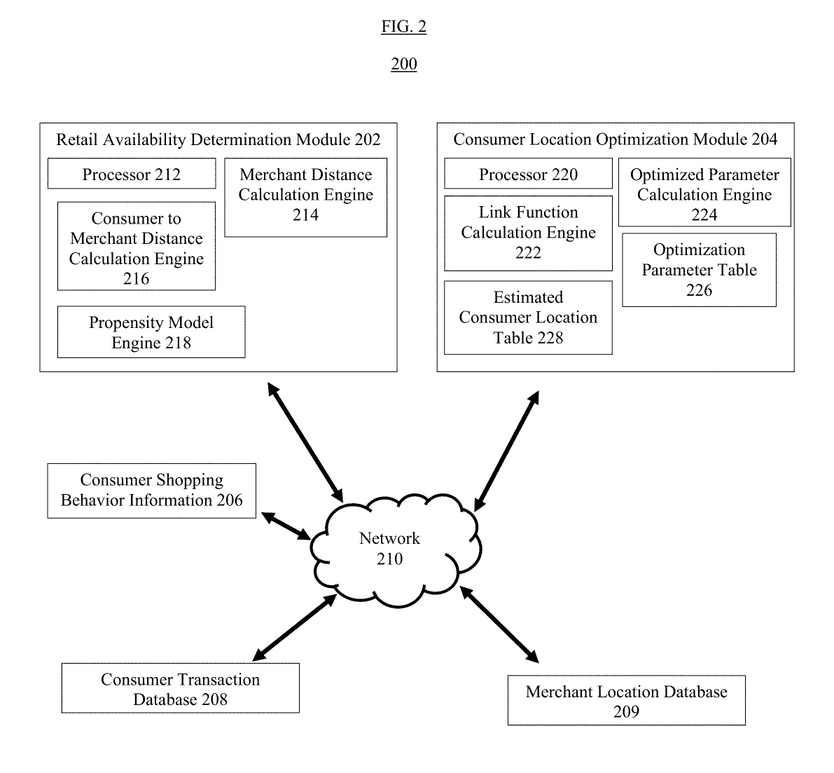

FIG. 2 depicts a block diagram illustrating a representative system 200 for determining local retail availability according to an illustrative embodiment of the disclosed subject matter. The exemplary system 200 can include at least a retail availability determination module 202, a consumer location optimization module 204, consumer shopping behavior information 206, a consumer transaction database 208, a merchant location database 209, which can all communicate with each other over network 210. Network 210 may be a wireless network, local area network, the world wide web, or any other suitable network.

In some embodiments, the retail availability determination module 202 and consumer location optimization module 204 can be both be part of the same entity and can share computing resources. For example, the processor 220 and processor 212 can be part of the same processor and/or can share processing circuitry and/or processing software. In some other embodiments, the retail availability determination module 202 and consumer location optimization module 204 can be independent entities that do not share the same resources and can be located in different locations.

As embodied herein, the retail availability determination module 202 can include a processor 212, a merchant distance calculation engine 214, a consumer to merchant distance calculation engine 216, and a propensity model calculation engine 218. The retail availability determination module 202 can determine merchant local availability for each user and integrates, as inputs, such local availability, information into a propensity model engine 218, which takes as inputs, other consumer shopping behavior information 206 (e.g., consumer needs, affordability, etc.) to determine each consumer's propensity to shop at each of a variety of different merchants. The retail availability determination module 202 can determine local availability data of merchants and categorize such information by distances to consumer's approximated location to nearest different merchant categories. By identifying, from consumers' transaction data, the location of each transaction, the retail availability determination module 202 can identify the consumer's distance to each merchant location and/or a particular merchant in each merchant category. The retail availability determination module 202 can communicate with the consumer location optimization module 204 to refine the consumer's location in real time based on the consumers' transactions to constantly refine consumers' locations. In some embodiments, the consumer's residential location (e.g., as identified from a directory and/or address book) can be retrieved by the retail availability determination module 202 in addition to the consumer's transaction history to determine the consumer's location. In some embodiments, by determining from the local availability data produced by the retail availability determination module 202, online retail merchants can determine that there are no merchants in a given merchant category for a particular consumer. From such information provided by the retail availability determination module 202, online merchants can intelligently provide services and/or recommendations to fill the gaps by identifying which consumers lack access to local merchants in a given merchant category.

In some embodiments, the merchant distance calculation engine 214, under instructions from processor 212, can calculate each merchant's distance from the center of a particular zip code. The retail availability determination module 202 can determine, from one or more sources such as merchant location database 209, the location (e.g., a latitude and longitude) of each particular merchant. The merchant distance calculation engine 214 can further identify from such merchant location information, the merchant in each merchant category that is closest to the center of each given zip code. The merchant distance calculation engine 214 can create a database and/or table (e.g., such as table 400 illustrated in FIG. 4) that stores the distance from the center of each zip code to the closest merchant in each merchant category to that corresponding zip code. Such a table can be used by the retail availability determination module 202 to calculate the distance from consumer to merchant.

In some embodiments, the consumer to merchant distance calculation engine 216 can calculate the distance between each potential consumer and the nearest merchant per merchant category available to that particular potential consumer. The retail availability determination module 202 can retrieve each consumer's location from the consumer location optimization module 204 (e.g., from the estimated consumer location table 228 which is shown in greater detail in table 500 illustrated in FIG. 5). The consumer to merchant distance calculation engine 216 can use the consumer's location to calculate the distance from each merchant in a given merchant category to calculate the distance between each consumer and the nearest merchant in a given merchant category.

In some embodiments, upon calculating such a merchant-to-consumer distance (hereinafter also referred to as the “local retail availability”), the propensity model engine 218 can update a propensity model estimating a consumer's shopping behavior by factoring in the local retail availability per given merchant category. To calculate such a propensity model, the propensity model engine 218 can also include consumer shopping behavior information 206, which can be obtained by the retail availability determination module 202 from one or more sources. The consumer shopping behavior information 206 can include data on the consumer's needs (e.g., frequency of purchases, types of purchases, how recently each type of item was purchased, etc.) and the consumer's affordability (e.g., total amount of spending per consumer, total amount spent in each merchant category, amount spent per visit to each merchant, maximum and minimum amounts spent per visit to each merchant, etc.). The propensity model generated by propensity model engine 218 can be used to identify potential consumers per merchant category who might have a high affinity for shopping at a given merchant given their shopping behavior information 206 and the local retail availability of that merchant category and can identify potential consumers who would be ideal candidates for online consumers to target in a particular merchant category because that particular consumer does not have access to a local storefront merchant in that merchant category near them. Such information can be used for survey purposes, targeted advertising purposes, promotion generation purposes, and/or other consumer segmentation purposes. For example, upon identifying at least one merchant category to which the potential consumer does not have local availability, the processor 212 can identify an electronic commerce merchant and/or an electronic commerce portal on the Internet of a merchant in that identified merchant category. The processor 212 can identify a promotion being offered by the electronic commerce merchant to new customers and/or to preexisting customers and provide such a promotion to the potential consumer (e.g., by e-mail, text and/or multimedia message, app notification, phone call, postal mail, etc.).

As embodied herein, the consumer location optimization module 204 can include at least a processor 220, a link function calculation engine 222, an optimized parameter calculation engine 224, an optimization parameter table 226, and an estimated consumer location table 228. Under instructions from processor 220, the consumer location optimization module 204 can determine, for each consumer, available residential address information (e.g., by querying their credit card account information, financial institution account information, address directories, etc.). In some embodiments, if the consumer location optimization module 204 cannot determine a consumer's residential address information it can estimate their location by using their consumer transaction information retrieved from consumer transaction database 208 as described in some embodiments of the disclosed subject matter. In some embodiments, the consumer location optimization module 204 can supplement the consumer's residential address information with their estimated location, obtained by using their consumer transaction information retrieved from consumer transaction database 208 as described in some embodiments of the disclosed subject matter, to provide a more accurate estimate of the consumer's location than their residential address information (e.g., if the user no longer lives in the address specified by their residential and/or has moved temporarily to another location but has not updated their residential address information).

In some embodiments, the link function calculation engine 222 can determine a parameter weighted center of transaction latitude and longitude location (hereinafter also referred to as “the estimated consumer location”) by computing a link function using the location from each transaction history activity of the consumer. For example, the consumer location optimization module 204 can determine a latitude and longitude of each transaction performed by the consumer and can weight each of these transactions using different parameter weights. By weighting each transaction and the latitude-longitude information associated with each transaction differently using different weights on a per transaction level per consumer, the link function calculation engine 222 can calculate a parameter weighted center of such transaction latitude-longitude information to estimate the consumer's location. The link function calculation engine 222 can compute a nonlinear link function in terms of parameters constrained on a per consumer level. The parameters used by the link function calculation engine 222 can be optimized at a per transaction level using a machine learning process implemented by the optimization parameter engine 224.

In some embodiments, the link function calculation engine 222 can use the following link function to calculate the estimated consumer location:

$$\hat{X} = F ( β ) = \frac{{Σ}_{i} {β}_{l ( i , a )}^{2} {x}_{i}}{{Σ}_{i} {β}_{l ( i , a )}^{2}} \qquad ( 1 )$$

where xᵢ represents the latitude-longitude of the consumer's ith transaction as obtained from the consumer transaction database 209 and β_{l(i,a)} is the optimization parameter of the lth level parameter mapped by ith transaction calculated by the optimization parameter engine 224. As referred to hereinafter, l(i,a) can represent the transaction category for a customer a's ith transaction. The link function calculation engine can compute the estimated consumer location by using the following constraints: Σᵢβᵢ=1 and βᵢ≥0. Current approaches of using a simple regression prediction model to estimate the consumer location using transaction information cannot estimate an accurate location because parameters must be normalized at an account level so that the predicted value is close to the transaction latitude-longitudes. The disclosed subject matter can overcome such a limitation faced by current approaches, by having the link function calculation engine use a set of Lagrange multipliers at the account level to implement these account level constraints to compute the estimated consumer location.

In some embodiments, the optimization parameter engine 224 can optimize the parameter set (e.g., each of the multiple weighting parameters) used by the link function for each consumer on a per transaction basis using a machine learning process. The optimization parameter engine 224 can determine optimal parameters using the following minimum of the sum square error equation:

$$ϕ = \frac{1}{2} {\sum }_{a} {\{ {X}_{a} - \frac{{Σ}_{i} {β}_{l ( i , a )}^{2} {x}_{a , i}}{{Σ}_{i} {β}_{l ( i , a )}^{2}} \}}^{2} \qquad ( 2 )$$

where x_{a,i} can represent the latitude for the consumer a's ith transaction. φ is the sum of square residuals (e.g., deviations predicted from actual empirical values of transaction latitude-longitude information) and is a measure of the discrepancy between the transaction latitude-longitude data (i.e., data obtained from the consumer transaction database 209) and the estimation model. φ(β) is the error equations for weight parameters β. In some embodiments, φ can be used as an optimality criterion in parameter selection and model selection.

In some embodiments, the optimization parameter engine 224 can calculate the parameters using a gradient descending approach. For example, the optimization parameter engine 224 can use the gradient descending approach described by the equations 3 and 4 below:

$$\begin{matrix}{β}_{s} ( n + 1 ) = {β}_{s} ( n ) - t \frac{\partial ϕ}{\partial {β}_{s}} & ( 3 ) \\ {ϕ}_{s}^{′} = \frac{\partial ϕ}{\partial {β}_{s}} = {\sum }_{a} ( {X}_{a} - \frac{{Σ}_{i} {β}_{l ( i , a )}^{2} {x}_{a , i}}{{Σ}_{i} {β}_{l ( i , a )}^{2}} ) ( - ) \frac{\begin{matrix}2 \times {Σ}_{i} {β}_{l ( i , a )}^{2} \times \\ {Σ}_{i} {δ}_{l ( i , a ) , s} {β}_{l ( i )} {x}_{a , i} - \\ 2 \times [ {Σ}_{i} {β}_{l ( i , a )}^{2} {x}_{a , i} ] \times \\ {Σ}_{i} {δ}_{l ( i , a ) , s} {β}_{l , ( i , a )}\end{matrix}}{{( {Σ}_{i} {β}_{l ( i , a )}^{2} )}^{2}} & ( 4 )\end{matrix}$$

where t is a positive number for learning speed of the machine learning algorithm, and where δ_{l(i),s}=1 and where s equals the transaction parameter category. δ_{l(i,a),s} is an indicator function, l(i,a) is the category for transaction i of customer a, and s is the specific transaction category for which the partial derivative

$$\frac{\partial ϕ}{\partial {β}_{s}}$$

for β is obtained. βₛ can represent the weight parameter which can be optimized for transaction category s. βₛ^{k} can represent βₛ on the kth iteration when optimizing β using the gradient descent method. In some embodiments, if s=l(i,a), the function δ_{l(i,a),s} takes value of 1, otherwise assign a value of 0 can be assigned to δ_{l(i,a),s}. Since there can be multiple transactions for the same parameters, different transactions must be weighted and the sum of the different weight parameters can be employed to proportionately weight the transactions. In some embodiments, the weighted average of transactions' locations as predicted by residential location can be used. In some embodiments, the weights (i.e., parameters) can be the same within each merchant category.

In some embodiments, equation (2) can define the loss (i.e., square error function) which can take β as a dependent variable. In some embodiments, the optimal β can be determined to minimize the loss function (i.e., equation (2)). In some embodiments, equation (3) can define the method used to find the optimal β, hereinafter also referred to as the gradient descent method. The gradient descent method can be executed for multiple iterations and in each iteration, β can be updated to β(n+1) in order to lower the value of loss function (i.e., equation (2)) based on the current β's current value β(n). In some embodiments, equation (3) can be used to obtain the direction of update for β which is

$$- \frac{\partial ϕ}{\partial {β}_{s}} , and \frac{\partial }{\partial {β}_{s}}$$

for use in equation (4).

In some embodiments, the optimization parameter engine 224 can calculate the initial parameters for each parameter level and can store them in the optimization parameter table 226. For example, the optimization parameter engine 224 can calculate the initial parameter βₛ for each category s using equation 5 (i.e., the square average error in latitude and longitude) and equation 6 below:

$$\begin{matrix}Square average error in latitude - longitude = ϕ ( s ) = \frac{{Σ}_{a , i} \{ {( {X}_{a} - {x}_{a , i} )}^{2} \times {δ}_{l ( i , a ) , s} \}}{N ( s )} & ( 5 ) \\ {β}_{s}^{0} = \frac{{ϕ}_{max}}{{ϕ}_{s}} & ( 6 )\end{matrix}$$

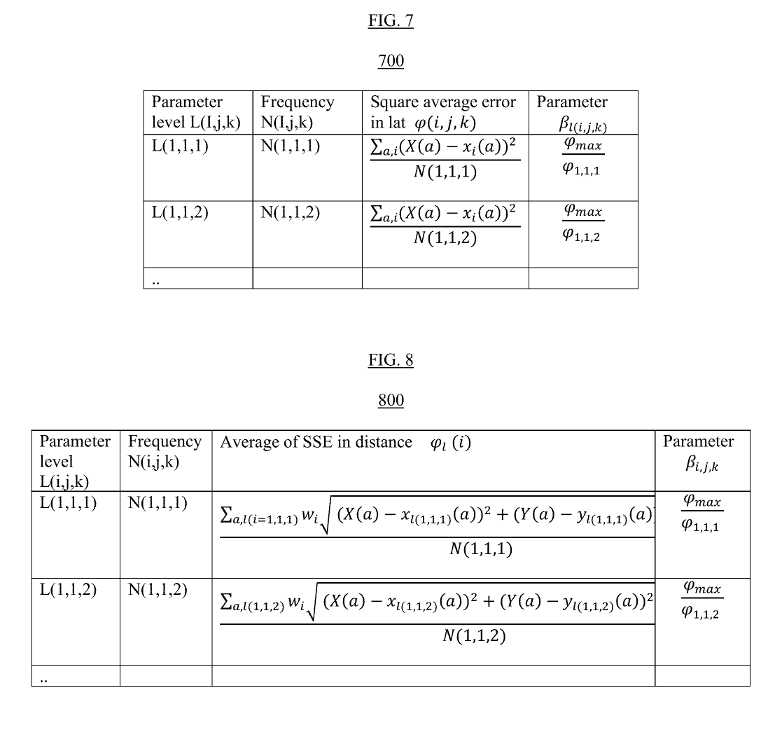

Optimization parameter table 226 is illustrated in further detail by table 700 in FIG. 7.

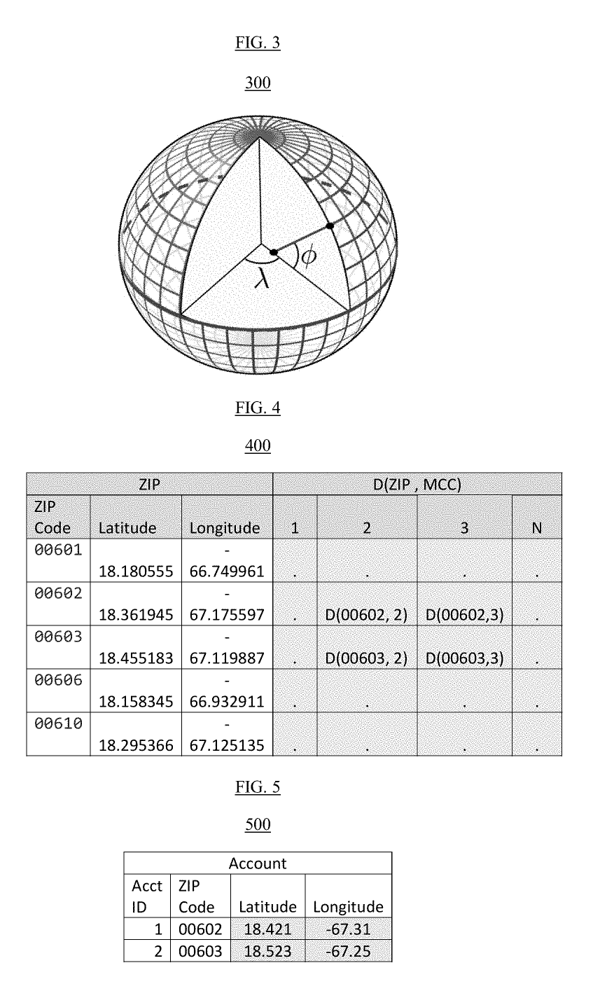

In some embodiments, the optimization parameter calculation engine 224 can implement a two-dimensional machine learning process for minimal distance to optimize the initial parameter for each parameter level. For example, the weight coefficients can be independent of direction, latitude, and longitude. Accordingly, in some embodiments, there can be a single set of optimal parameters for both latitude and longitude by minimum of distance. For example, the sum of square of error in distance in two-dimensions can be approximated by the following local flat formula 7:

$$D = \frac{R}{57.2} \sqrt{{Δϕ}^{2} + {Δλ}^{2} {cos}^{2} ( ϕ )} \qquad ( 7 )$$

where R equals 6371 km (e.g, 3958.3 miles) as described in more detail below in connection with FIG. 3.

In some embodiments, the optimization parameter calculation engine 224 can weight some merchants' latitude-longitude information differently due to the data quality of the collected transaction data from consumer transaction database 208. For example, a consumer can shop outside his typical residential area when he is on vacation and/or out of town and transaction data at such foreign merchants can be weighted differently than the local merchants in the consumer's local area for purposes of calculating local retail availability and estimating the consumer's location. In order to perform such weighting, a weight factor for data quality can be introduced to the final optimization algorithm by calculating the sum of squares taking such weighting into account as shown in equation 8 below:

$$ϕ = \frac{1}{2} {\sum }_{a} \{ {\{ {X}_{a} - \frac{{Σ}_{i} {w}_{a , i} {β}_{l ( i , a )}^{2} {x}_{a , i}}{{Σ}_{i} {w}_{a , ii} {β}_{l ( i , a )}^{2}} \}}^{2} + {\{ {Y}_{a} - \frac{{Σ}_{i} {w}_{a , i} {β}_{l ( i , a )}^{2} {y}_{a , i}}{{Σ}_{i} {w}_{a , i} {β}_{l ( i , a )}^{2}} )}^{2} {cos}^{2} {X}_{a} \} \qquad ( 8 )$$

where y_{a,i} can represent the longitude for the consumer a's ith transaction.

In some embodiments, upon calculating the weighted sum of square errors, the optimization parameter calculation engine 224 can minimize the weighted sum of squares by calculating an iteration equation. For example, the weighted sum of square errors illustrated in equation 8 above can be minimized according to equations 9 and 10 below:

$$\begin{matrix}{β}_{s} ( n + 1 ) = {β}_{s} ( n ) - t \frac{\partial ϕ}{\partial {β}_{s}} & ( 9 ) \\ {ϕ}_{s}^{′} = \frac{\partial ϕ}{\partial {β}_{s}} = - {Σ}_{a} \{ ( {X}_{a} - \frac{{Σ}_{i} {w}_{a , i} {β}_{l ( i , a )}^{2} {x}_{a , i}}{{Σ}_{i} {w}_{a , i} {η}_{l ( i , a )}^{2}} ) \times \frac{\begin{matrix}\begin{matrix}\begin{matrix}2 \times {Σ}_{i} {w}_{a , i} {β}_{l ( i , a )}^{2} \times \\ {Σ}_{i} {δ}_{l ( i , a ) , s} {w}_{a , i} {β}_{l ( i , a )} {x}_{a , i} -\end{matrix} \\ 2 \times [ {Σ}_{i} {w}_{a , i} {β}_{l ( i , a )}^{2} {x}_{a , i} ] \times \end{matrix} \\ {Σ}_{i} {δ}_{l ( i , a ) , s} {w}_{a , i} {β}_{l ( i , a )}\end{matrix}}{{( {Σ}_{i} {w}_{i} {β}_{l ( i )}^{2} )}^{2}} + ( {Y}_{a} - \frac{{Σ}_{i} {w}_{a , i} {β}_{l ( i , a )}^{2} {y}_{a , i}}{{Σ}_{l} {w}_{a , i} {β}_{l ( i , a )}^{2}} ) \times \frac{\begin{matrix}\begin{matrix}\begin{matrix}2 \times {Σ}_{i} {w}_{a , i} {β}_{l ( i , a )}^{2} \times \\ {Σ}_{i} {δ}_{l ( i , a ) , s} {w}_{a , i} {β}_{l ( i , a )} {y}_{a , i} -\end{matrix} \\ 2 \times [ {Σ}_{i} {w}_{a , i} {β}_{l ( i , a )}^{2} {y}_{a , i} ] \times \end{matrix} \\ {Σ}_{i} {δ}_{l ( i , a ) , s} {w}_{a , i} {β}_{l ( i , a )}\end{matrix}}{{( {Σ}_{i} {w}_{i} {β}_{l ( i )}^{2} )}^{2}} \times {cos}^{2} X ( a ) \} & ( 10 )\end{matrix}$$

The optimization parameter calculation engine 224 can calculate the average of sum of square errors in distance φₗ (i) for each parameter level L(i,j,k) and can store the results in optimization parameter table 226 as shown by table 800 described in greater detail below with connection to FIG. 8.

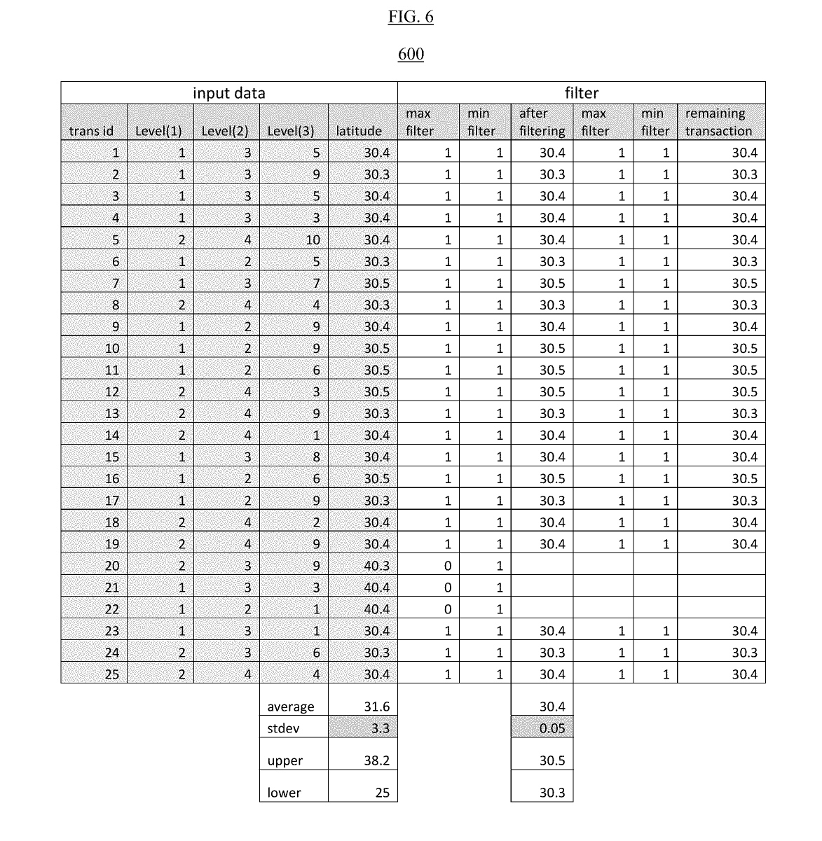

In some embodiments, transaction data that is marked to be atypical (e.g., shopping activity when consumer is out of town) can be removed from the transaction data considered to calculate the consumer's estimated location. This is shown in greater detail in table 600 illustrated in FIG. 6.

In some embodiments, once the optimization parameter calculation engine 224 calculates the optimized weighted parameters, the link function calculation engine 222 can use the optimized parameters from the optimization parameter table 226 to calculate each consumer's estimated location, which can be populated in estimated consumer location table 228. The retail availability determination module 202 can retrieve estimated consumer location from table 228 to calculate the local retail availability, which is used to refine the propensity model.

FIG. 3 is a diagram illustrating a representation of a sphere used to calculate distance using the orthodromic distance formula. As shown by the globe, the shortest distance between two points on the surface of sphere can be calculated using the following equalion:

$$D = \frac{R}{57.2} \sqrt{{Δϕ}^{2} + {Δλ}^{2} {cos}^{2} ( ϕ )}$$

where R=6371 (i.e., 3958.3 miles) and where φ and λ is the difference in latitude and longitudes of the two points on the sphere. The merchant distance calculation engine 214 can use such an equation to calculate the shortest distance between the center of each zip code and each selected merchant in the merchant category nearest that zip code. Similarly, the consumer to merchant distance calculation engine 216 can also use such a formula to calculate the shortest distance between each consumer's estimated location and each selected merchant in the merchant category nearest that consumer's estimated location.

FIG. 4 is a table 400 illustrating the distance from various merchants to different zip codes. As described previously, the merchant distance calculation engine 214 can create table 400 that stores the distance from the center of each zip code to the closest merchant in each merchant category to that corresponding zip code. Such a table can be used by the retail availability determination module 202 to calculate the distance from consumer to merchant. The merchant distance calculation engine 214 can include the latitude and longitude of the center of each zip code (e.g., 00602, 00603, etc.), which the merchant distance calculation engine 214 can retrieve from a publicly available postal code database. The merchant distance calculation engine 214 can also include, in table 400, the shortest distance calculated between the center of each zip code and the location of the nearest merchant in each given merchant category code (MCC) (e.g., columns labeled 1, 2, 3 in table 400). The merchant distance calculation engine 214 can use the orthodromic distance formula described in FIG. 3 to calculate the shortest distance used to populate table 400 between merchant locations and the center of each zip code.

FIG. 5 is a table illustrating the estimated consumer locations for various consumer locations. The consumer location optimization module 204 can generate table 500 (e.g., also described as estimated consumer location table 228 in FIG. 2) according to the processes described in greater detail above in connection with FIG. 2. As illustrated in FIG. 5, table 500 can include the estimated latitude and longitude of each consumer (e.g., ACCT ID). Table 500 can also include the estimated zip code associated with the consumer (e.g., by associating the estimated latitude and longitude of the consumer against a database of different zip codes and their associated latitude-longitude information). The retail availability determination module 202 can use the consumer location from table 500 to calculate the shortest distance between each consumer and the nearest merchant in each merchant category to the consumer using the orthodromic distance formula described in FIG. 3.

FIG. 6 is a table illustrating an example of different transaction information of a particular consumer and location information associated with each transaction. As shown in FIG. 6, table 600 can include the latitude associated with each transaction of the particular consumer (e.g., trans id). Such latitude information can be received from the consumer transaction database 209 and/or by looking up the location of the merchant associated with the given transaction. As described above in connection with FIG. 2, the consumer location optimization module 204 can filter out transactions that are atypical (e.g., transactions that occur for a short period of time at a significantly different latitude/location than the majority of the consumer's transactions indicating that the consumer is likely out of town for a temporary period of time). Table 600 can include multiple different levels of filtering (e.g., Level (1), Level (2), Level (3), etc.). Each of these different levels of filtering can correspond to an expanded category (i, j, k), which can be updated to a unified one-dimension category s. The category identifier can be re-assigned using such a unified one-dimension category for filtering (e.g, category 1 can be reassigned to (1, 1, 1), category 2 can be reassigned to (1, 1, 2), etc.). For example, such a filtering procedure can filter out the outlier transactions that occur at a location far away from the consumer's residential address (shown in table 600 of FIG. 6 as transactions #20, 21, and 22 which occur at a significantly different latitude than the rest of the transactions) from the rest of the transactions in the transaction information dataset. In some embodiments, transactions that occur outside two standard deviations from a consumer's predetermined central location of transactions (i.e., the determined residential address of the consumer based on the transaction data) can be filtered out and such a process can be repeated recursively.

FIG. 7 illustrates table 700 which shows how initial optimization parameters are calculated for each parameter level using square average error in latitude information. As mentioned previously in connection with FIG. 2, optimization parameter engine 224 can calculate the initial parameters for each parameter level and can store them in table 700. For example, the optimization parameter engine 224 can calculate the initial parameter βₛ for each parameter category s using the following equations:

$$ϕ ( s ) = \frac{{Σ}_{a , i} \{ {( {X}_{a} - {x}_{a , i} )}^{2} \times {δ}_{l ( i , a ) , s} \}}{N ( s )} ,$$

where N(s) is the frequency of that parameter level (i.e., s) and

$${β}_{s} = \frac{{ϕ}_{max}}{{ϕ}_{s}} .$$

FIG. 8 illustrates table 800 which shows how weighting coefficients are calculated using the sum of square of error in latitude information available from consumer transaction database 208 and/or table 600. As mentioned previously in connection with FIG. 2, optimization parameter engine 224 can calculate the optimized parameters for each parameter level using the average sum square error in distance per parameter level and can store them in table 800. For example, the optimization parameter engine 224 can calculate a single parameter-level independent optimized parameter β_{(i,j,k)} for each parameter level 1 using the following equations:

$$ϕ ( i , j , k ) = \frac{{Σ}_{a , l ( i , j , k )} {w}_{i} \sqrt{{( X ( a ) - {x}_{l ( i , j , k )} ( a ) )}^{2} + {( Y ( a ) - {y}_{l ( i , j , k )} ( a ) )}^{2} {cos}^{2} X ( a )}}{N ( i , j , k )} ,$$

where N(i,j,k) is the frequency of that parameter level (i, j, k) and

$${β}_{( i , j , k )} = \frac{{ϕ}_{max}}{{ϕ}_{i , j , k}} .$$

FIG. 8 can provide an initial value for β, which can be close to an optimal value of β. The initial value of β can be inversely proportional to the average of the sum square error equation (i.e., equation 2). Accordingly, a higher value βₛ can be assigned if the consumer's residential address is closer to his transactions in category s.

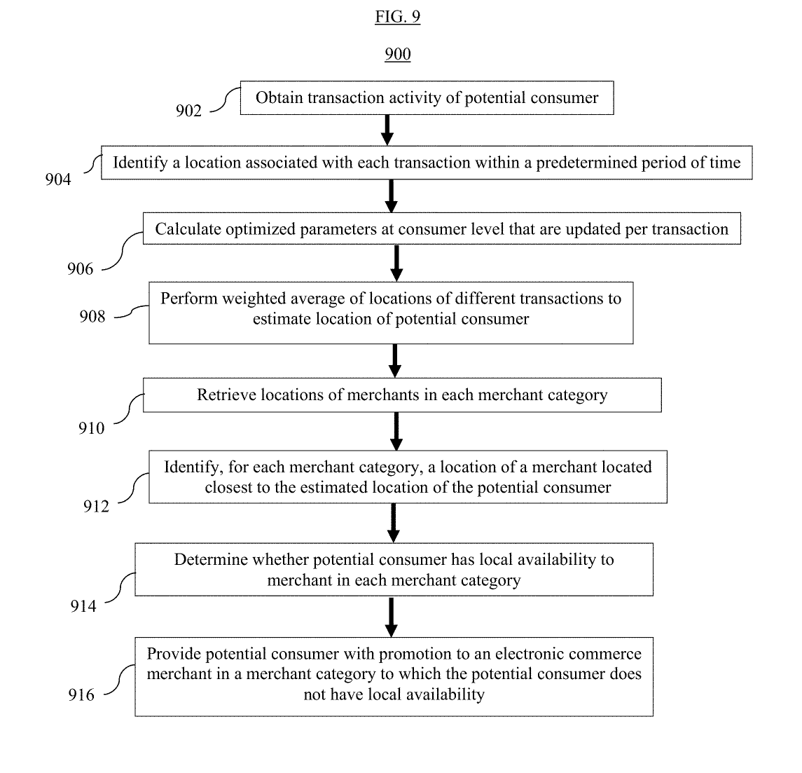

FIG. 9 is a flow chart illustrating a representative method 900 for calculating local retail availability per potential consumer, implemented according to an illustrative embodiment of the disclosed subject matter. The exemplary network 100 of FIG. 1 and system 200 of FIG. 2, tables of FIGS. 4-8, for purpose of illustration and not limitation, are discussed with reference to the exemplary method 900 of FIG. 9.

At step 902, the processor can obtain transaction activity of a potential consumer. For example, processor 212 of retail availability determination module 202 can obtain transaction activity for each potential consumer from consumer transaction database 208.

At step 904, the processor can identify a location associated with each transaction conducted within a predetermined period of time. For example, each transaction can be associated with a location of the merchant at which the transaction was conducted. In some embodiments, processor 220 of consumer location optimization module 204 can determine the latitude and/or longitude associated with each transaction as shown in FIG. 6. In some embodiments, the processor can remove, from the transactions considered to estimate the potential consumer's location, locations of transactions that are conducted when the potential consumer is temporarily conducting transactions at a location that is not in his typical location.

At step 906, the processor can calculate optimized parameters at a consumer level that are updated per transaction. For example, processor 220 can determine the optimized parameter by iterating through different parameter values until a parameter value is found that minimizes deviations between empirical values of measured locations from each transaction activity and the estimated location. In some embodiments, the processor 220 can calculate these deviations using a machine learning algorithm that performs a minimum of least squares between measured locations from each transaction activity and the estimated location. In some embodiments, the processor 220 can calculate the optimized parameter by calculating an initial parameter for each transaction based on the square average error measured between the location of each transaction activity and the estimated location and the frequency of a parameter level corresponding to the transaction activity. In some embodiments, the processor 220 can calculate the optimized parameter by calculating a sum of square average error using a two-dimensional distance value, that is generated based on an orthodromic distance formula used to calculate the shortest distance between two points on the surface of sphere.

At step 908, the processor can perform weighted average of locations of different transactions to estimate location of the potential consumer. For example, processor 220 can use the optimized parameters for each transaction calculated in step 906 to calculate the weighted average of the transaction activity per consumer to estimate the location of the potential consumer.

At step 910, the processor can retrieve locations of merchants in each merchant category. For example, merchant distance calculation engine 214 can obtain the location of the of different merchants from publicly available data and/or different sources.

At step 912, the processor can identify, for each merchant category, a location of a merchant located closest to the estimated location of the potential consumer. For example, the consumer to merchant distance calculation engine 216 can calculate distance from each merchant to the center of each zip code as shown in table 400 and compare data from table 400 against table 500, which associates each user with an estimated location to identify the closest merchant in each merchant category to each consumer.

At step 914, the processor can determine whether the potential consumer has local availability to a merchant in each merchant category. For example, the processor 212 can determine whether the merchant located in each merchant category located nearest the consumer is within a preset threshold distance away from the consumer.

At step 916, the processor can provide the potential consumer with a promotion to an electronic commerce merchant in a merchant category to which the potential consumer does not have local availability. For example, upon identifying at least one merchant category to which the potential consumer does not have local availability in step 614, the processor 212 can identify an electronic commerce merchant and/or an electronic commerce portal on the Internet of a merchant in that identified merchant category. The processor 212 can identify a promotion being offered by the electronic commerce merchant to new customers and/or to preexisting customers and provide such a promotion to the potential consumer (e.g., by e-mail, text and/or multimedia message, app notification, phone call, postal mail, etc.).

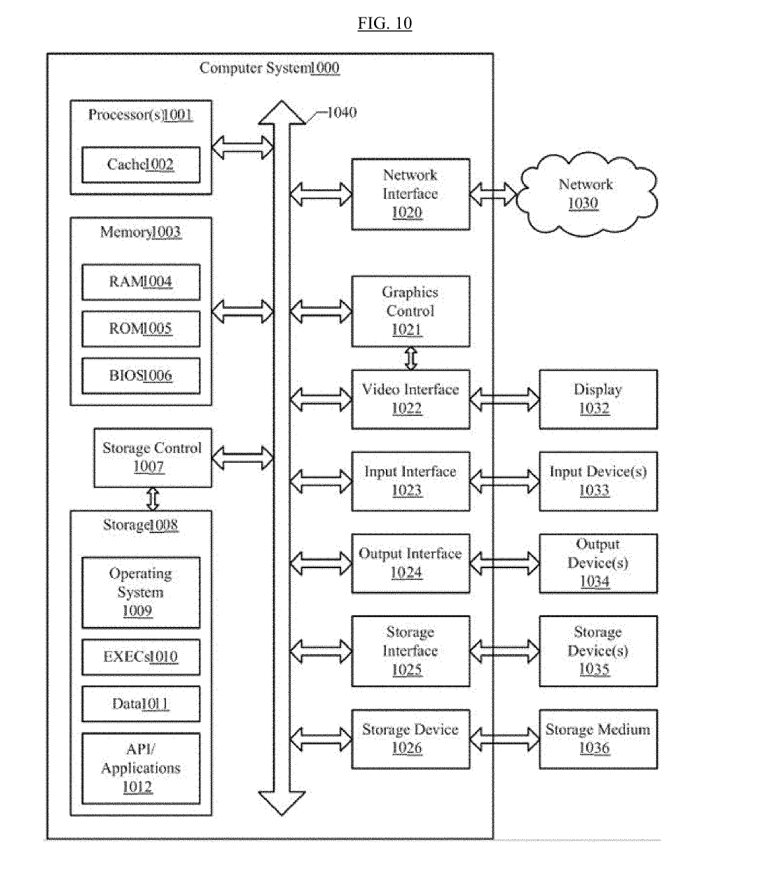

FIG. 10 is a block diagram illustrating further details of a representative computer system according to an illustrative embodiment of the disclosed subject matter.

The systems and techniques discussed herein can be implemented in a computer system. As an example and not by limitation, as shown in FIG. 10, the computer system having architecture 1000 can provide functionality as a result of processor(s) 1001 executing software embodied in one or more tangible, non-transitory computer-readable media, such as memory 1003. The software implementing various embodiments of the present disclosure can be stored in memory 1003 and executed by processor(s) 1001. A computer-readable medium can include one or more memory devices, according to particular needs. Memory 1003 can read the software from one or more other computer-readable media, such as mass storage device(s) 1035 or from one or more other sources via communication interface 1020. The software can cause processor(s) 1001 to execute particular processes or particular parts of particular processes described herein, including defining data structures stored in memory 1003 and modifying such data structures according to the processes defined by the software. An exemplary input device 1033 can be, for example, a keyboard, a pointing device (e.g. a mouse), a touchscreen display, a microphone and voice control interface, a pressure sensor or the like to capture user input coupled to the input interface 1023 to provide data and/or user input to the processor 1001. An exemplary output device 1034 can be, for example, a display (e.g. a monitor) or speakers or a haptic device coupled to the output interface 1024 to allow the processor 1001 to present a user interface, visual content, and/or audio content. Additionally or alternatively, the computer system 1000 can provide an indication to the user by sending text or graphical data to a display 1032 coupled to a video interface 1022. Furthermore, any of the above components can provide data to or receive data from the processor 1001 via a computer network 1030 coupled the communication interface 1020 of the computer system 1000. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 1001 includes hardware for executing instructions, such as those making up a computer program. As an example and not by way of limitation, to execute instructions, processor 1001 can retrieve (or fetch) the instructions from an internal register, an internal cache 1002, memory 1003, or storage 1008; decode and execute them; and then write one or more results to an internal register, an internal cache 1002, memory 1003, or storage 1008. In particular embodiments, processor 1001 can include one or more internal caches 1002 for data, instructions, or addresses. This disclosure contemplates processor 1001 including any suitable number of any suitable internal caches, where appropriate. As an example and not by way of limitation, processor 1001 can include one or more instruction caches 1002, one or more data caches 1002, and one or more translation lookaside buffers (TLBs). Instructions in the instruction caches 1002 can be copies of instructions in memory 1003 or storage 1008, and the instruction caches 1002 can speed up retrieval of those instructions by processor 1001. Data in the data caches 1002 can be copies of data in memory 1003 or storage 1008 for instructions executing at processor 1001 to operate on; the results of previous instructions executed at processor 1001 for access by subsequent instructions executing at processor 1001 or for writing to memory 1003 or storage 1008; or other suitable data. The data caches 1002 can speed up read or write operations by processor 1001. The TLBs can speed up virtual-address translation for processor 1001. In some embodiments, processor 1001 can include one or more internal registers for data, instructions, or addresses. This disclosure contemplates processor 1001 including any suitable number of any suitable internal registers, where appropriate. Where appropriate, processor 1001 can include one or more arithmetic logic units (ALUs); be a multi-core processor; or include one or more processors 1001. Although this disclosure describes and illustrates a particular processor, this disclosure contemplates any suitable processor.

In some embodiments, memory 1003 includes main memory for storing instructions for processor 1001 to execute or data for processor 1001 to operate on. As an example and not by way of limitation, computer system 1000 can load instructions from storage 1008 or another source (such as, for example, another computer system 1000) to memory 1003. Processor 1001 can then load the instructions from memory 1003 to an internal register or internal cache 1002. To execute the instructions, processor 1001 can retrieve the instructions from the internal register or internal cache 1002 and decode them. During or after execution of the instructions, processor 1001 can write one or more results (which can be intermediate or final results) to the internal register or internal cache 1002. Processor 1001 can then write one or more of those results to memory 1003. In some embodiments, processor 1001 executes only instructions in one or more internal registers or internal caches 1002 or in memory 1003 (as opposed to storage 1008 or elsewhere) and operates only on data in one or more internal registers or internal caches or in memory 1003 (as opposed to storage 1008 or elsewhere). One or more memory buses (which can each include an address bus and a data bus) can couple processor 1001 to memory 1003. Bus 640 can include one or more memory buses, as described below. In particular embodiments, one or more memory management units (MMUs) reside between processor 1001 and memory 1003 and facilitate accesses to memory 1003 requested by processor 1001. In some embodiments, memory 1003 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 1003 can include one or more memories 1004, where appropriate. Although this disclosure describes and illustrates particular memory, this disclosure contemplates any suitable memory.

In some embodiments, storage 1008 includes mass storage for data or instructions. As an example and not by way of limitation, storage 1008 can include a hard disk drive (HDD), a floppy disk drive, flash memory, an optical disc, a magneto-optical disc, magnetic tape, or a Universal Serial Bus (USB) drive or a combination of two or more of these. Storage 1008 can include removable or non-removable (or fixed) media, where appropriate. Storage 1008 can be internal or external to computer system 1000, where appropriate. In some embodiments, storage 1008 is non-volatile, solid-state memory. In some embodiments, storage 1008 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1008 taking any suitable physical form. Storage 1008 can include one or more storage control units facilitating communication between processor 1001 and storage 1008, where appropriate. Where appropriate, storage 1008 can include one or more storages 1008. Although this disclosure describes and illustrates particular storage, this disclosure contemplates any suitable storage.

In some embodiments, input interface 1023 and output interface 1024 can include hardware, software, or both, providing one or more interfaces for communication between computer system 1000 and one or more input device(s) 1033 and/or output device(s) 1034. Computer system 1000 can include one or more of these input device(s) 1033 and/or output device(s) 1034, where appropriate. One or more of these input device(s) 1033 and/or output device(s) 1034 can enable communication between a person and computer system 1000. As an example and not by way of limitation, an input device 1033 and/or output device 1034 can include a keyboard, keypad, microphone, monitor, mouse, printer, scanner, speaker, still camera, stylus, tablet, touch screen, trackball, video camera, another suitable input device 1033 and/or output device 1034 or a combination of two or more of these. An input device 1033 and/or output device 1034 can include one or more sensors. This disclosure contemplates any suitable input device(s) 1033 and/or output device(s) 1034 and any suitable input interface 1023 and output interface 1024 for them. Where appropriate, input interface 1023 and output interface 1024 can include one or more device or software drivers enabling processor 1001 to drive one or more of these input device(s) 1033 and/or output device(s) 1034. Input interface 1023 and output interface 1024 can include one or more input interfaces 1023 or output interfaces 1024, where appropriate. Although this disclosure describes and illustrates a particular input interface 1023 and output interface 1024, this disclosure contemplates any suitable input interface 1023 and output interface 1024.

As embodied herein, communication interface 1020 can include hardware, software, or both providing one or more interfaces for communication (such as, for example, packet-based communication) between computer system 1000 and one or more other computer systems 1000 or one or more networks. As an example and not by way of limitation, communication interface 1020 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1020 for it. As an example and not by way of limitation, computer system 1000 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 1000 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 can include any suitable communication interface 1020 for any of these networks, where appropriate. Communication interface 1020 can include one or more communication interfaces 1020, where appropriate. Although this disclosure describes and illustrates a particular communication interface, this disclosure contemplates any suitable communication interface.

In some embodiments, bus 1040 includes hardware, software, or both coupling components of computer system 1000 to each other. As an example and not by way of limitation, bus 1040 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1040 can include one or more buses 1004, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A computer-implemented method for determining local availability of a merchant, comprising:
identifying, by a processing circuitry, an estimated location of a potential consumer based at least in part on transaction activity of the potential consumer;
identifying, by the processing circuitry and for each merchant category, a location of a merchant located closest to the estimated location of the potential consumer from a plurality of merchants in the merchant category;
determining, by the processing circuitry and for each merchant category, whether the potential consumer has local availability of a merchant based on the identified location of the merchant located closest to the estimated location of potential consumer for the corresponding merchant category; and
providing, by the processing circuitry, the potential consumer with a promotion to an electronic commerce merchant in a merchant category to which the potential consumer does not have local availability.

2. The computer-implemented method of claim 1, wherein identifying the estimated location of the potential consumer further comprises:
identifying, by the processing circuitry, a location associated with each transaction conducted by the potential consumer within a predetermined period of time based on the transaction activity of the potential consumer; and
performing, by the processing circuitry, a weighted average of the locations of one or more transactions from the transaction activity of the potential consumer.

3. The computer-implemented method of claim 2, further comprising removing, from the weighted average, locations of transactions that are conducted when the potential consumer is temporarily conducting transactions at a location that is not in his typical location.

4. The computer-implemented method of claim 2, wherein performing the weighted average further comprises calculating, by the processing circuitry, an optimized parameter at a consumer level, wherein the optimization parameter is updated at a per transaction level based on each transaction activity of the potential consumer.

5. The computer-implemented method of claim 4, wherein the optimized parameter is determined by iterating, by the processing circuitry, through different parameter values until a parameter value is found that minimizes deviations between empirical values of measured locations from each transaction activity and the estimated location.

6. The computer-implemented method of claim 5, wherein the deviations are calculated using a machine learning algorithm that performs a minimum of least squares between measured locations from each transaction activity and the estimated location.

7. The computer-implemented method of claim 4, wherein calculating the optimized parameter further comprises calculating, by the processing circuitry, an initial parameter for each transaction based on the square average error measured between the location of each transaction activity and the estimated location and the frequency of a parameter level corresponding to the transaction activity.

8. The computer-implemented method of claim 4, wherein calculating the optimized parameter further comprises calculating, by the processing circuitry, a sum of square average error using a two-dimensional distance value, wherein the two-dimensional distance value is generated based on an orthodromic distance formula used to calculate the shortest distance between two points on the surface of sphere.

9. The computer-implemented method of claim 1, further comprising generating, by the processing circuitry, targeted promotions to the potential consumer based on the determination of local availability of a merchant in each merchant category.

10. The computer-implemented method of claim 1, further comprising updating, by the processing circuitry, a model of consumer shopping behavior based on the determination of local availability of a merchant for each merchant category, wherein the model further comprises information on spending patterns indicating needs of the potential consumer and price range of purchases made by the potential consumer.

11. An apparatus for determining local availability of a merchant, comprising:
a processor configured to communicate with a consumer transaction database, the processor configured to:
identify an estimated location of a potential consumer based at least in part on transaction activity of the potential consumer obtained from the consumer transaction database;
identify, for each merchant category, a location of a merchant located closest to the estimated location of the potential consumer from a plurality of merchants in the merchant category;
determine, for each merchant category, whether the potential consumer has local availability of a merchant based on the identified location of the merchant located closest to the estimated location of potential consumer for the corresponding merchant category; and
provide the potential consumer with a promotion to an electronic commerce merchant in a merchant category to which the potential consumer does not have local availability.

12. The apparatus of claim 11, wherein the processor is further configured to identify the estimated location of the potential consumer by:
identifying a location associated with each transaction conducted by the potential consumer within a predetermined period of time based on the transaction activity of the potential consumer; and
performing a weighted average of the locations of one or more transactions from the transaction activity of the potential consumer.

13. The apparatus of claim 12, wherein the processor is further configured to remove, from the weighted average, locations of transactions that are conducted when the potential consumer is temporarily conducting transactions at a location that is not in his typical location.

14. The apparatus of claim 12, wherein the processor is further configured to perform the weighted average by calculating an optimized parameter at a consumer level, wherein the optimization parameter is updated at a per transaction level based on each transaction activity of the potential consumer.

15. The apparatus of claim 14, wherein the processor is further configured to determine the optimized parameter by iterating through different parameter values until a parameter value is found that minimizes deviations between empirical values of measured locations from each transaction activity and the estimated location.

16. The apparatus of claim 15, wherein the processor is further configured to calculate deviations using a machine learning algorithm that performs a minimum of least squares between measured locations from each transaction activity and the estimated location.

17. The apparatus of claim 14, wherein the processor is further configured to calculate the optimized parameter by calculating an initial parameter for each transaction based on the square average error measured between the location of each transaction activity and the estimated location and the frequency of a parameter level corresponding to the transaction activity.

18. The apparatus of claim 14, wherein the processor is further configured to calculate the optimized parameter by calculating a sum of square average error using a two-dimensional distance value, wherein the two-dimensional distance value is generated based on an orthodromic distance formula used to calculate the shortest distance between two points on the surface of sphere.

19. The apparatus of claim 11, wherein the processor is further configured to generate targeted promotions to the potential consumer based on the determination of local availability of a merchant in each merchant category.

20. The apparatus of claim 11, wherein processor is further configured to update a model of consumer shopping behavior based on the determination of local availability of a merchant for each merchant category, wherein the model further comprises information on spending patterns indicating needs of the potential consumer and price range of purchases made by the potential consumer.
